(19) United States
(12) Patent Application Publication
(10) Pub. No.: US 2021/0121020 A1
(43) Pub. Date: Apr. 29, 2021

(54) FOOD SPINNER ATTACHMENT FOR ELECTRIC HAND BLENDERS

(71) Applicant: Dominique Hamel, Montreal (CA)

(72) Inventor: Dominique Hamel, Montreal (CA)

(21) Appl. No.: 16/848,232

(22) Filed: Apr. 14, 2020

Related U.S. Application Data
(60) Provisional application No. 62/973,767, filed on Oct. 25, 2019.

(51) Int. Cl. A47J 43/07

(52) U.S. Cl. CPC A47J 43/0711; A47J 2043/04427

(57) ABSTRACT

A food spinner as an attachment for an electric hand blender comprises an outer bowl, an inner perforated basket and a two-part lid. The lid assembly has a recess for receiving a gearbox assembly, comprising a gearbox and a coupling that are driven by a hand blender. The gearbox element is configured to transfer, and possibly reduce, the rotational speed of the hand blender's motor to the coupling, which in turn transfers this speed to the drive plate of the lid. When in place and rotatably engaged, the drive plate transmits rotations from the driver unit to the perforated basket which may then spin food.

### CROSS-REFERENCE TO RELATED APPLICATIONS

The present patent application claims the benefits of priority of commonly owned provisional American Patent Application No. 62/973,767, entitled “FOOD SPINNER ATTACHMENT FOR ELECTRIC HAND BLENDER” and filed at the American Patent Office on Oct. 25, 2019.

### FIELD OF THE INVENTION

This invention relates to attachment devices for electrical hand blenders containing a motor drive. More specifically, it relates to attachment devices for spinning food.

### BACKGROUND OF THE INVENTION

Mass produced fruits and vegetables possess a risk of food contamination and it is thus imperative to wash produces such as lettuce, spinach, kale, fresh herbs, berries and the like before consumption. Some people may find this process, especially the steps of washing and drying, long and tedious. Plus, the existing manual salad spinners may often have disappointing results and may require a considerable physical effort from users. Such negative aspects may discourage users from properly doing each step of the process which in return may make them entirely skip washing the food.

In recent years, hand blending appliances, referred also as “immersion blender” or “stick mixers,” have become extremely popular for commercial and domestic use in the preparation of a wide variety of foods. Such appliances often include an operative end which is immersible in fluids and has a rotatable blade which extends therefrom. Such appliances are generally used to blend or mix fluids such as smoothies, soups, vinaigrettes, purées, sauces or the like. To add to the versatility of such appliances, attachments may be provided to enable the appliance to whip liquids or to chop solids.

Generally, a hand blender comprises a handle housing a motor and mechanically coupled to a stem that features a rotatable blade at one end and a coupling for the motor at its other end. Because the handle and the stem of the hand blender are detachable, the handle portion may be used to drive a food spinner's rotating basket. However, the output rotational speed of a hand blender's motor is generally higher than the rotational speed required by a food spinner. Therefore, it may be required to install a speed reducing gearbox between the hand blender's motor and the food spinner. The speed achieved would be reduced compared to the one delivered directly from hand blender, but superior to the speed possible on any existing manual salad spinner. A speed reducing gearbox may provide a rotational speed to the food spinner that is slower than what is transmitted directly from hand blender's motor drive while still being faster than what is possible with manual food spinners. There is also a need for a gearbox that is not permanently housed within a food spinner so the other components of the food spinner may be submerged or washed in a dish washer.

Accordingly, it would be desirable for a food spinner to function as an attachment for an electric hand blender which may reduce the effort needed in washing and drying food and which may optimize the results of the same practices compared to manual food spinners.

Instead of a separate electric appliance, the consumer would use it as an attachment for an existing hand blender thereby extending the use of that appliance to perform as an electric food spinner.

### SUMMARY OF THE INVENTION

The aforesaid and other objectives of the present invention are realized by generally providing an appliance that combines a hand blender's motorized part, subsequently mainly referred to as hand blender, and a food spinner. In a first aspect of the invention is provided a gearbox that is interposed between the motor of the hand blender and the mechanical input of the food spinner is removable from a lid assembly. The removable gearbox allows the lid assembly to be washed in a dish washer. The lid assembly that retains the gearbox can be moulded in a clear material that allows visibility of the food within the food spinner.

Among the many advantages provided by the food spinner attachment of the present invention are its ability to be readily engaged and disengaged from the driver shaft of an electric hand blender's motorized part and its ability to be driven at a desired reduced speed by a speed-reducing drive transmission through a drive plate and thereby spinning the basket from its outer perimeter to maintain structural integrity. The food spinner attachment is efficient, easy to install and remove, and may quickly and effortlessly dry the fruits and vegetables at an optimal rotational speed with optimal centrifugal forces.

In a second aspect of the invention is provided a food spinner attachment made for a hand blender of the type and having a lid assembly comprising in its central axis a gearbox assembly sleeve for engaging with the hand blender driver shaft containing a speed reducing transmission to obtain the necessary speed between the perimeter of a rotatable drive plate and the top perimeter of a rotatable basket, maintaining the structural integrity of the basket while rotating.

In another aspect of the invention is provided an outer bowl which may have an uninterrupted side wall and a bottom for catching and holding any water spinned out of the basket and drained down its inside surface. The basket may be perforated on its side wall and bottom and may be rotatably mounted in the outer bowl such that it may assure the predetermined position of the basket for rotation around a main vertical axis. Food placed in the perforated rotatable basket may be spinned and dried such that the water may be collected on the inner surfaces of the outer bowl.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a side view of an embodiment of a food spinner with a hand blender attached.

FIG. 2 is a side view of the food spinner of FIG. 1 without the hand blender attached.

FIG. 3 is a sectional side view of an embodiment of a food spinner.

FIG. 4A is a top view of an embodiment of a gearbox.

FIG. 4B is a sectional view of the gearbox of FIG. 4A.

FIG. 4C is a bottom view of the gearbox of FIG. 4A.

FIG. 5A is a top view of an embodiment of a coupling assembly.

FIG. 5B is a sectional view of the coupling assembly of FIG. 5A.

FIG. 5C is a bottom view of the coupling assembly of FIG. 5A.

FIG. 6 is a top view of the food spinner of FIG. 1 without the hand blender attached.

FIG. 7 is a bottom view of an embodiment of a drive plate.

FIG. 8 is a top view of an embodiment of a basket.

### DETAILED DESCRIPTION OF THE PREFERRED EMBODIMENT

A novel food spinner attachment for electric hand blenders will be described hereinafter. Although the invention is described in terms of specific illustrative embodiment(s), it is to be understood that the embodiment(s) described herein are by way of example only and that the scope of the invention is not intended to be limited thereby.

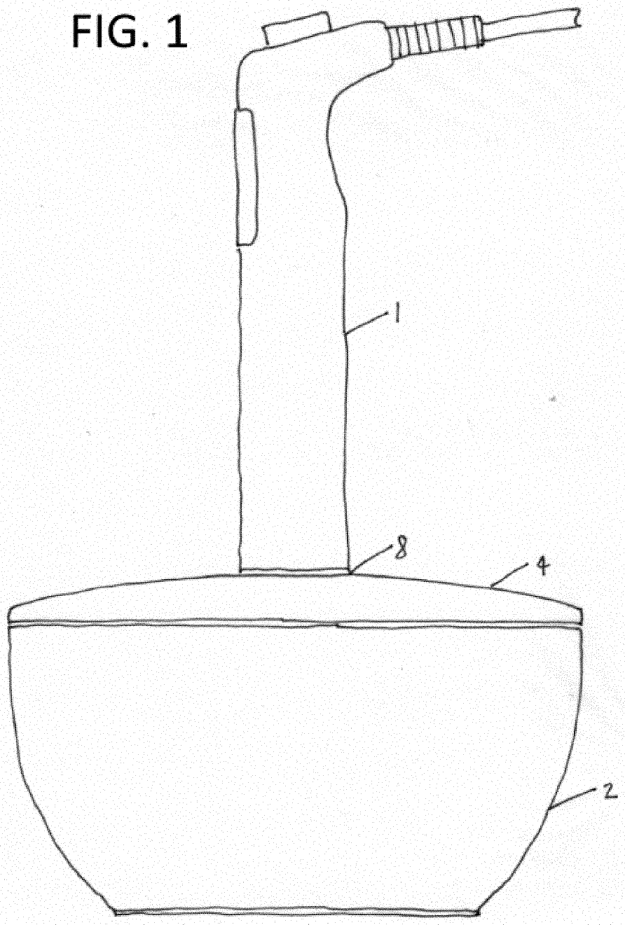

Referring to FIGS. 1-8, a food spinner generally includes a container having a bowl 2 and a cover 5 for the bowl 2, a perforated basket 3 disposed in the bowl 2, a drive plate 6 for the basket 3 and a drive assembly 8 for rotating the perforated basket 3 via the drive plate 6 relative to the container.

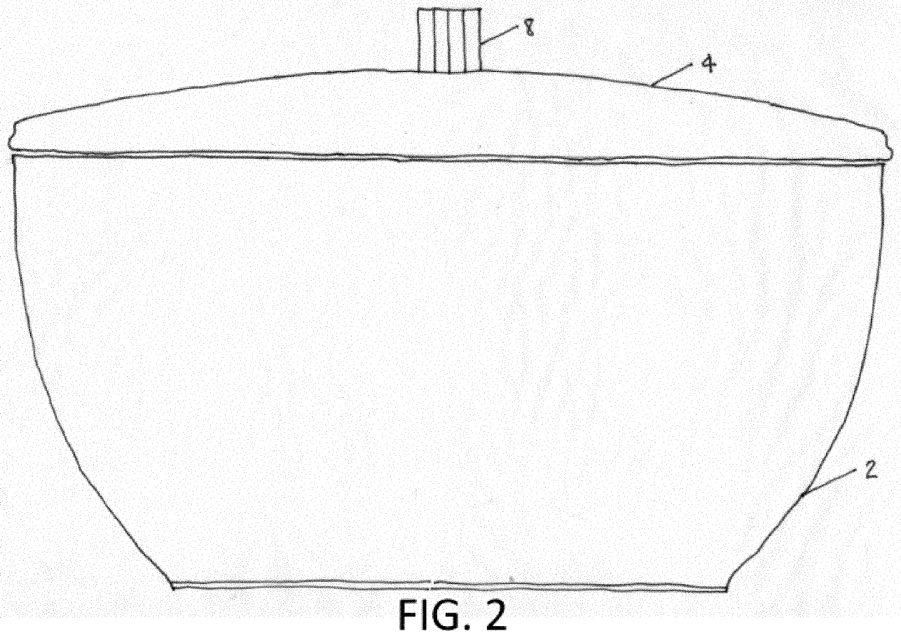

An embodiment of a food spinner 2 may be seen in FIGS. 1 and 2. Presented is a food spinner 2 attached to the handle portion of an electrical hand blender 1 comprising a motor. The food spinner 2 may be mechanically attached to the hand blender 1 with the aid of a gearbox assembly 8.

The gearbox assembly 8 provided may be removable from the food spinner 2. It may further be designed to be coaxially mounted between the rotational motion of the hand blender's 1 motor and the food spinner 2. A section or the entirety of the gearbox assembly 8 may be housed within the food spinner's lid 4. The gearbox assembly's 8 input and output couplings may be rigid so as not to disperse any noticeable forces in the transfer of rotational forces.

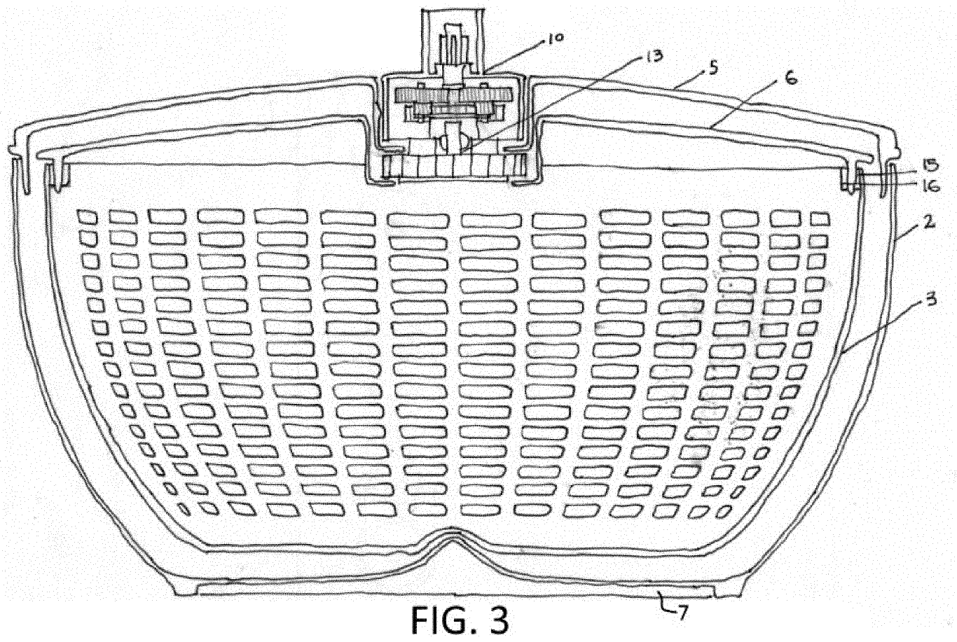

A schematic representation of an embodiment of a gearbox assembly 8 is shown in FIG. 3. In this embodiment, the assembly 8 is divided in two main components; one being a gearbox 10 and the other being a coupling assembly 13. In such an embodiment, the rotational movement and speed initiates from the motor of a hand blender. The rotational speed may then be transferred to the gearbox 10, which may then transfer it to the coupling assembly 13, which may then transfer it to the drive plate 6 which may finally transfer it to the perforated basket 3. In other embodiments, the gearbox assembly 8 may comprise more or less than two main components. In further embodiments, the gearbox assembly 8 may output a rotational speed equal or lower than its input rotational speed. In the embodiment of FIG. 3, the gearbox 10 is an epicyclic gear, also known as planetary gear. This gear 10 may reduce the incoming rotational speed lower to lower output speeds more suited for certain applications such as spinning salad. In some embodiments, the reduction ratio may be 3:1 while in others it might go up to 10:1.

The transmission between the drive plate 6 and the perforated basket 3 is possible with the engagement, when rotating, of the projecting ribs of both the drive plate 15 and the basket 16.

Encompassing the perforated basket is a bowl 2 circular in shape as seen in FIG. 3. It has a bottom wall having a cone-shaped projection in its center which may provide a vertical axis of rotation at its center. The exterior of the bottom surface of the bowl 2 may also include a non-slip material 7 to help maintain stability of the invention when the perforated basket 3 rotates.

The perforated basket 3 seen in FIG. 3 may include a bottom having a cone-shaped projection at its center which may sit atop the cone-shaped projection of the bowl 2 to form a rotational bearing. The basket's 3 cylindrical peripheral top edge may have ribs 16 projecting inwardly that may mate with the drive plate's 6 projecting ribs 15.

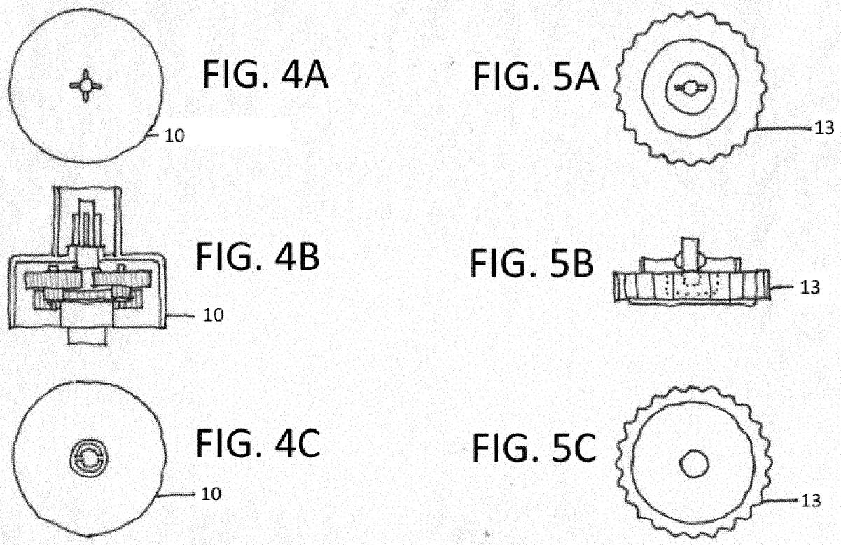

FIGS. 4A to 5C present separate parts of an embodiment of a gearbox assembly 8, respectively a gearbox 10 and a coupling assembly 13. The two parts, mounted axially, may allow a direct mechanical transfer of the rotational force coming from a hand blender's motor up to the drive plate 6. These parts may be further combined into one gearbox assembly or into multiple other parts. The gearbox assembly 8 may also be removable from the lid, making it possible to wash or submerge underwater the lid assembly when necessary. The invention may further comprise a latching mechanism of any convenient kind known in the art, such as a bayonet fixture or a snap-fitting, for detachably securing the hand blender to the gearbox assembly 8. It is to be understood that the gearbox assembly 8 may comprise multiple gear arrangements so as to convey a rotational force with a reduced speed if necessary. As such, the embodiment shown in FIG. 4A to 4C is an epicyclic gear manufactured to reduce an input rotational speed. The reduction ratio may vary depending on the design choice of the gear.

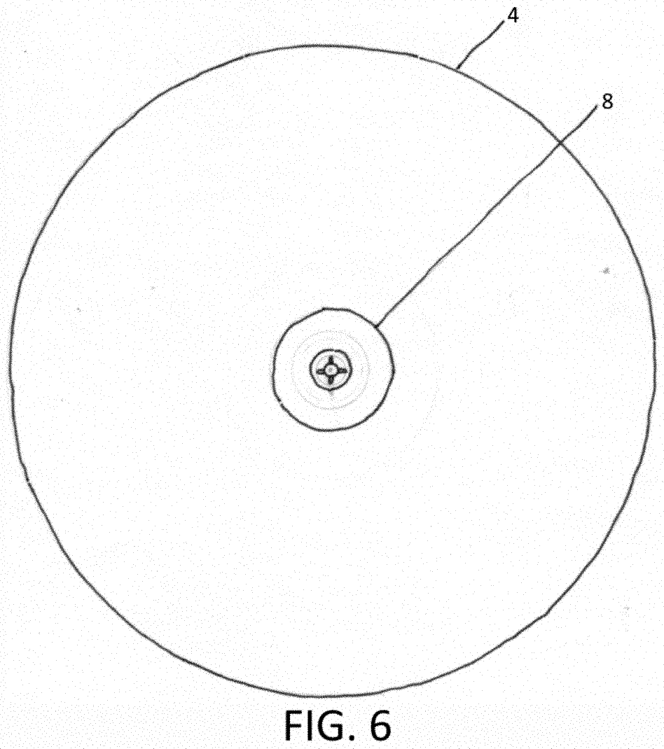

FIG. 6 presents a top view of the food spinner with the gearbox assembly 8 in a functional position. In the shown embodiment, rotating parts share the same central rotational axis. In other embodiments, the gearbox assembly 8 may have internal components having different rotational axis so as to reduce rotational speed with different gear sizes.

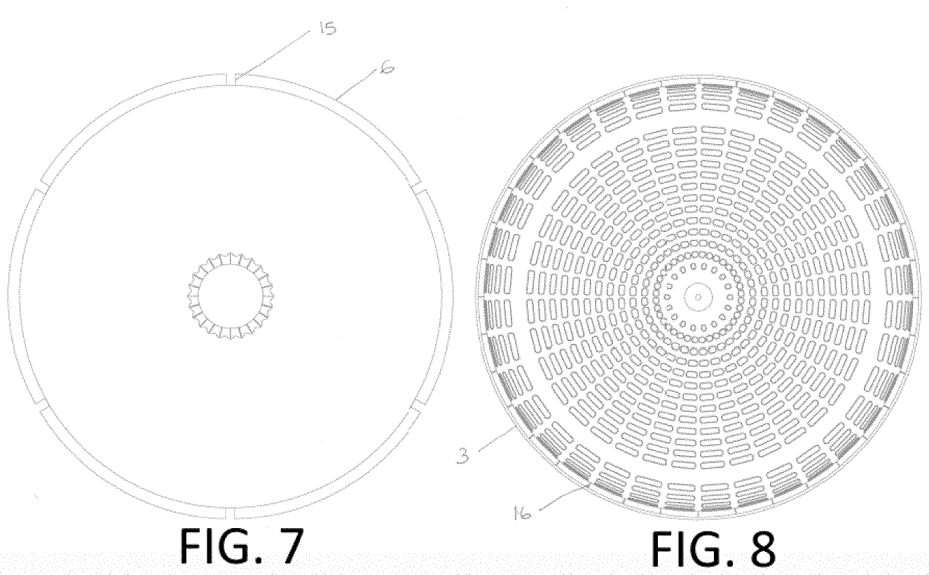

As seen in FIG. 7, the drive plate 6 may include a cylindrical peripheral sidewall having a plurality of outwardly projecting ribs 15. The basket 3, as shown in FIG. 8, may also include a plurality of inwardly projecting ribs 16 situated on the cylindrical peripheral top edge of its sidewall. Now referring to FIGS. 3, 7 and 8, the respective projecting ribs (15, 16) of the drive plate 6 and the basket 3 may mate and cooperate between each other's to provide a releasable coupling. As such, the driving plate's 6 ribs 15 may couple with and drive the ribs 16 of the basket 3 when a rotational force is initiated from the hand blender's 1 motor.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A food spinning attachment for use with an electrical hand blender comprising a motor drive, the attachment comprising:
a basket having an outer shell with a bottom and upwardly extending sidewalls and a holed inner shell with a bottom and upwardly extending sidewalls, the holed inner shell located inside the outer shell and having the same rotational axis;
a lid assembly having a top portion and a driving plate located under the top portion, the top portion covering the outer shell and the driving plate being engaged to the inner shell; and
a gearbox assembly having a rigid input connector for connection to the motor drive and a rigid output connector for transmitting a rotational force to the driving plate.

2. The food spinning attachment of claim 1, wherein the driving plate and holed inner shell comprise projecting ribs rotatably engaged together.

3. The food spinning attachment of claim 1, wherein the gearbox assembly is detachable from the lid assembly.

4. The food spinning attachment of claim 1, wherein the gearbox assembly is fixed to the lid assembly.

5. The food spinning attachment of claim 1, wherein the gearbox assembly output rotational speed is equal or lower than the input rotational speed.

6. The food spinning attachment of claim 1, wherein the lid assembly is made of a see-through material.

7. The food spinning attachment of claim 1, wherein the outer and holed inner shell have a cone shaped projection going upward in the center of their bottom surface, the axis of rotation of the holed inner shell cone shaped projection being the same as the axis of rotation of the outer shell cone shaped projection.

8. A food spinning attachment for use with an electrical hand blender comprising a motor drive, the attachment comprising:
a basket having an outer shell with a bottom and upwardly extending sidewalls and a holed inner shell with a bottom and upwardly extending sidewalls, the holed inner shell located inside the outer shell and having the same rotational axis;
a lid assembly having a top portion and a driving plate located under the top portion, the top portion covering the outer shell and the driving plate covering the holed inner shell; and
a gearbox assembly having a rigid input connector for connection to the motor drive and a rigid output connector for transmitting a rotational force to the driving plate, the gearbox assembly located within the cover plate and the top portion; wherein
the driving plate is transmitting a rotational force from the gearbox assembly to the holed inner shell;
the holed inner shell is rotating around its center axis when an external rotational force is applied to the gearbox assembly;
the holed inner shell is rotatably engaged to the driving plate with projecting ribs;
the gearbox assembly is detachable from the lid assembly; and
the gearbox assembly output rotational speed is equal or lower than the input rotational speed.

9. The food spinning attachment of claim 8, wherein the gearbox assembly is fixed to the lid assembly.

10. The food spinning attachment of claim 8, wherein the lid assembly is made of a see-through material.

11. The food spinning attachment of claim 8, wherein the outer and holed inner shell have a cone shaped projection going upward in the center of their bottom surface, the axis of rotation of the holed inner shell cone shaped projection being the same as the axis of rotation of the outer shell cone shaped projection.
